(19) United States
(12) Patent Application Publication
(10) Pub. No.: US 2019/0084679 A1
(43) Pub. Date: Mar. 21, 2019

(54) REMOTELY PILOTED AIRCRAFT SYSTEM

(71) Applicant: Aspira Aerial Applications Limited, Manchester (GB)

(72) Inventors: Stephen FALDER, Manchester (GB); Timothy ROBERTS, Manchester (GB); David JOLLEY, Manchester (GB)

(21) Appl. No.: 16/098,964

(22) PCT Filed: May 5, 2017
(86) PCT No.: PCT/GB2017/051259

§ 371 Date: Nov. 5, 2018

(30) Foreign Application Priority Data
May 5, 2016 (GB) 1607872.7

(51) Int. Cl. B64D 1/18; B64C 39/02; B64D 45/00; G05D 1/00; G05D 1/10

(52) U.S. Cl. CPC B64D 1/18; B64C 39/024; B64D 45/00; B64C 2201/06; G05D 1/101; B64C 2201/12; B64C 2201/148; G05D 1/0094

(57) ABSTRACT

Disclosed is an apparatus for applying a substance to a structure (1), comprising: a remotely piloted aircraft system, RPAS (100); means for ejecting the substance onto the structure; means (120) for supplying the substance from a reservoir (140) to the RPAS (100); a position maintenance system arranged to maintain a predetermined distance from the structure.

The present invention relates to a remotely piloted aircraft system (RPAS) which may be used, in particular, to apply a liquid coating, such as algicide, biocide, cleaning agents or non film forming liquids or paint to the exterior of a building or other structure. It may also be used to apply liquids to items other than buildings, such as ships, aircraft, wind turbines, electric pylons and oil & Gas rigs. The term ‘structure’ when used in this application should be construed to include any physical device, apparatus, building or vehicle

Presently, the application of a coating to an exterior of a structure can be problematic in cases where the structure in question is taller than can be safely managed by use of a ladder or cherry picker platform or is difficult to access from the ground below the area that needs to be coated. Structures such as multi-story dwellings or tower blocks can pose particular problems in this regard, being relatively high and requiring extensive scaffolding to ensure safe working practices for operatives.

Structures require regular maintenance to ensure that they are maintained in a safe and aesthetically pleasing condition. In particular, residential dwellings, such as tower blocks, should be painted periodically. Certain structures in certain locations also require the periodic application of an algicide product to prevent, or ameliorate the effects of, a build up of algae on its exterior.

Presently, in order to perform such a task, extensive preparation in the form of scaffolding may be required. Alternatively, personnel may be required to abseil down the building, applying the coating manually. For smaller structures, movable scaffold towers or cherry pickers may be deployed. In all these cases, the task is time consuming, expensive and can be dangerous.

There therefore exists a need to improve the process and apparatus by which a coating can be applied to an exterior of a structure. Embodiments of the present invention aim to address these and other problems with the prior art, whether identified herein or not.

According to the present invention there is provided an apparatus and method as set forth in the appended claims. Other features of the invention will be apparent from the dependent claims, and the description which follows.

According to a first aspect of the invention, there is provided an apparatus for applying a substance to a structure, comprising: a remotely piloted aircraft system, RPAS; means for ejecting the substance onto the structure; means for supplying the substance from a reservoir to the RPAS; a position maintenance system arranged to maintain a predetermined distance from the structure.

In an embodiment, the means for ejecting the substance comprises a lance. The lance is an elongate hollow member down which the substance can travel before being ejected at a tip through one of a variety of changeable nozzles.

In an embodiment, the lance comprises a relatively cushioned tip proximal the point of ejection. This is arranged to minimise the risk of damage to the structure, from the lance.

In an embodiment, the lance is releasably coupled to the RPAS, such that the lance may be jettisoned if required. The RPAS may be more easily controlled in the absence of the lance and so, in an emergency, the lance may be jettisoned.

In an embodiment, the means for supplying comprises an umbilical cable coupled to a reservoir. The umbilical cable is a flexible hose for conveying the coating substance to the apparatus. The substance may be pumped.

In an embodiment, the reservoir may be arranged to be sited either at ground level or atop the structure.

In an embodiment, the umbilical cable is further arranged to provide power to the apparatus from an external power source. A separate power cable may be arranged alongside the umbilical for supplying substance, or it may be located internal to the umbilical cable.

In an embodiment, the umbilical cable is still further arranged to carry data between the apparatus and a ground station. This data may comprise instructions from the ground station and/or telemetry data from the apparatus.

In an embodiment, the umbilical cable is further adapted to transfer data to and/or from the RPAS. In this way, navigational control data may be conveyed by the cable and/or data can be passed back to the operator or pilot.

In an embodiment, the position maintenance system comprises one or more sensors selected from: a LIDAR sensor; a camera; and an ultrasonic sensor and a GPS device. The exact choice of sensor or sensors will depend on user preference and the planned use of the apparatus.

In an embodiment, a first auxiliary propeller is provided, arranged to counteract a force associated with ejecting the substance and to tend to maintain a position or trajectory of the apparatus. The first auxiliary propeller is mounted either to the main body or to an arm extending therefrom. The axis of rotation of the propeller is arranged to be substantially orthogonal to the axis of rotation of each of the propellers of the propulsion system.

In another embodiment, one or more further auxiliary propellers are provided to facilitate movement in a plane parallel to a surface of the structure. This can allow simple sideways movement, without the need to tilt the RPAS, which would otherwise be required.

The auxiliary propeller or propellers can be provided with variable pitch rotors, which can obviate a need to tilt the RPAQS in flight to change direction.

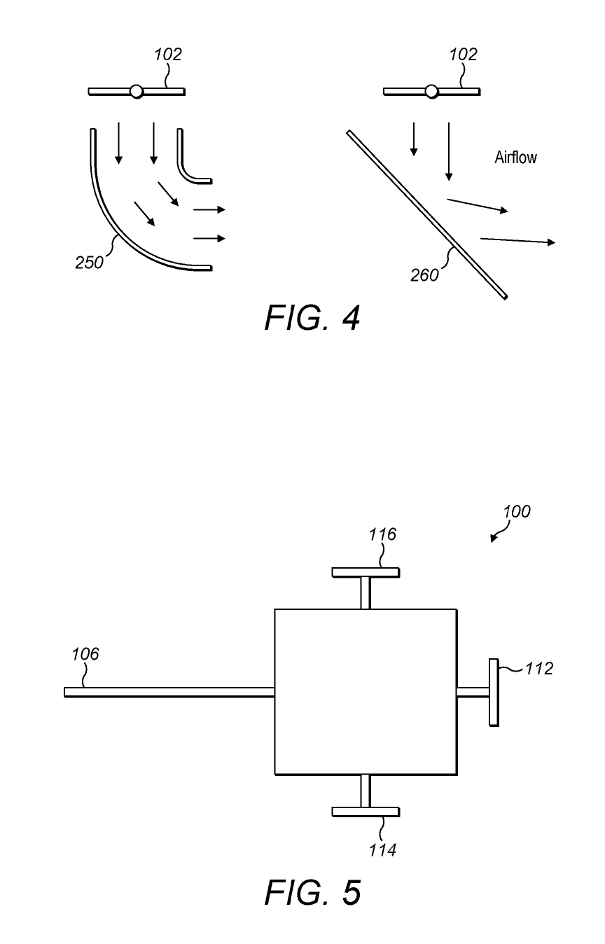

In another embodiment, RPAS position can be controlled, at least in part, by means of thrust vector control. This is illustrated in FIG. 4.

For a better understanding of the invention, and to show how embodiments of the same may be carried into effect, reference will now be made, by way of example, to the accompanying diagrammatic drawings in which:

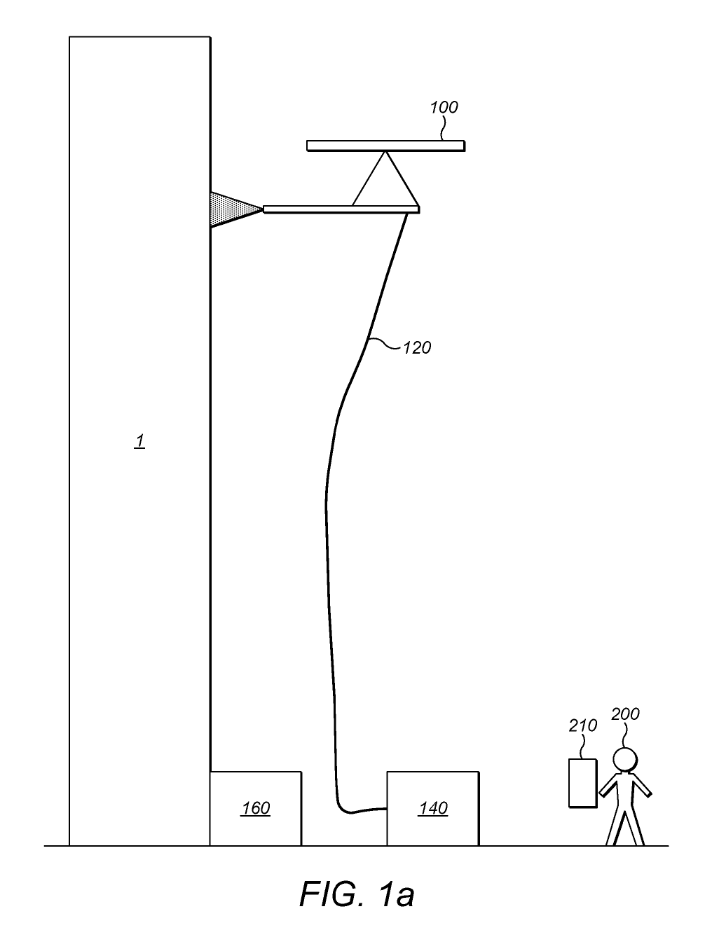

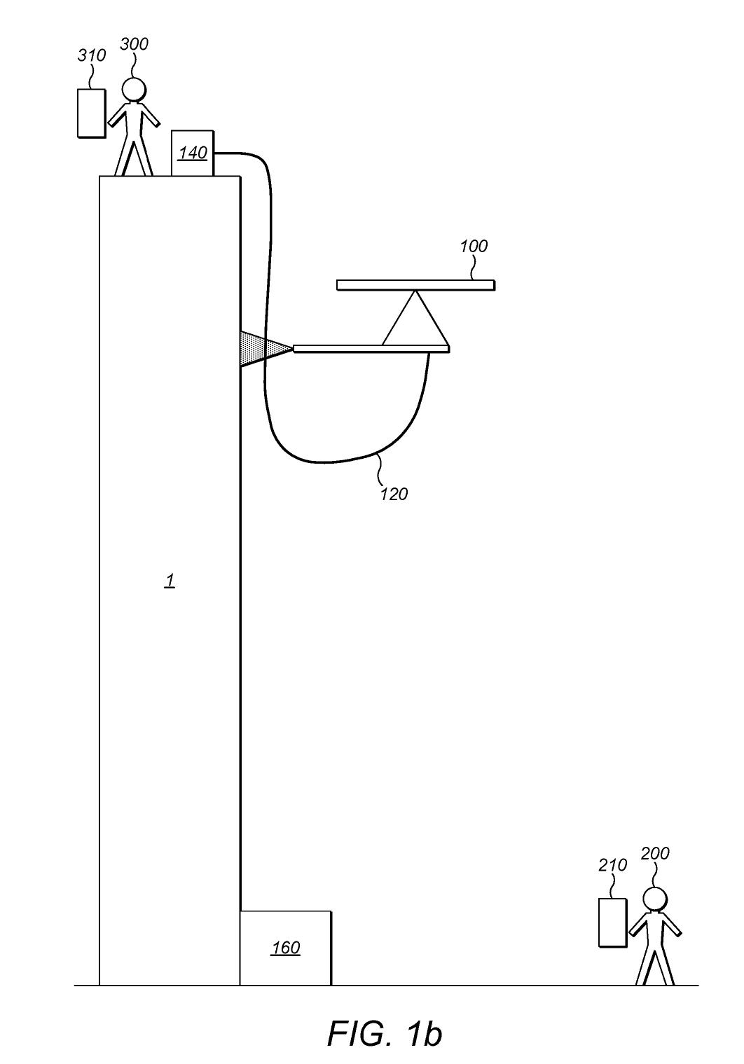

FIG. 1a shows an embodiment of the present invention in use;

FIG. 1b shows another embodiment of the present invention in use;

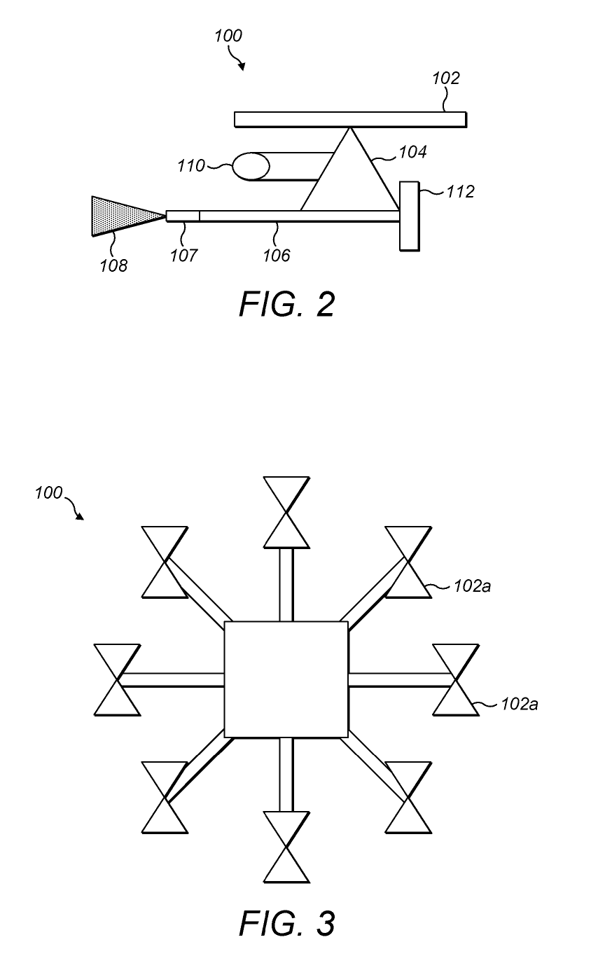

FIG. 2 shows a more detailed view of the embodiment of FIGS. 1a and 1b;

FIG. 3 shows a more detailed view of the propulsion system of an RPAS according to an embodiment of the invention;

FIG. 4 shows an illustration of thrust vector control according to an embodiment of the invention;

FIG. 5 shows additional auxiliary propellers according to an embodiment of the invention;

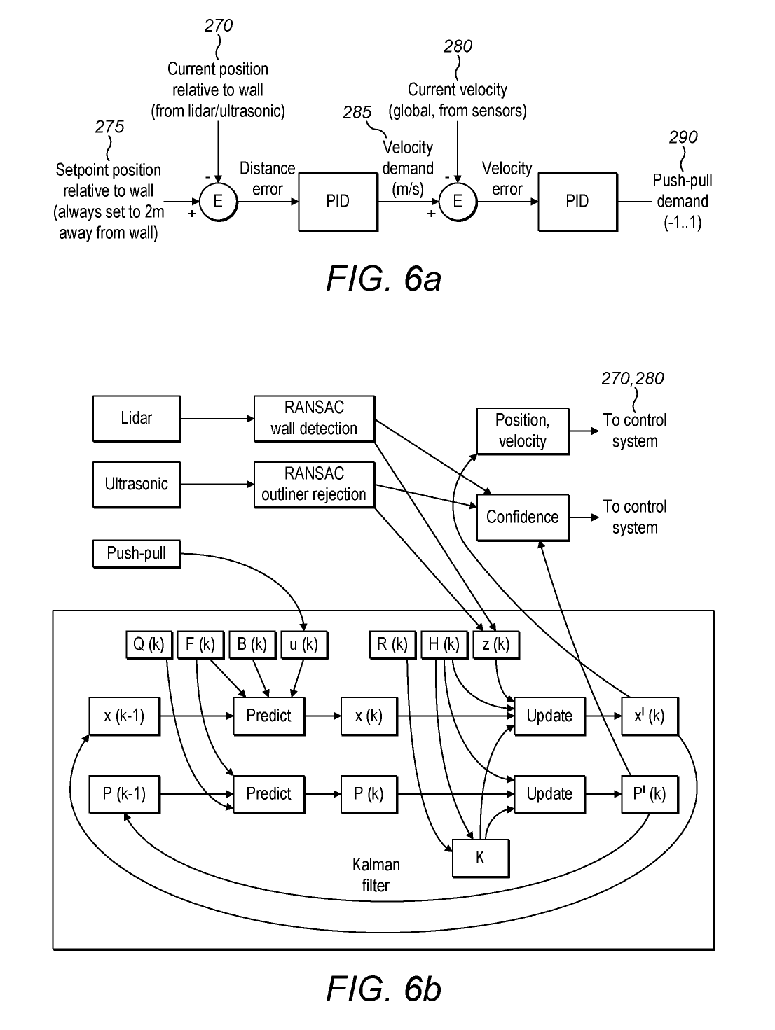

FIGS. 6a and 6b show details of a position maintenance system according to an embodiment of the invention;

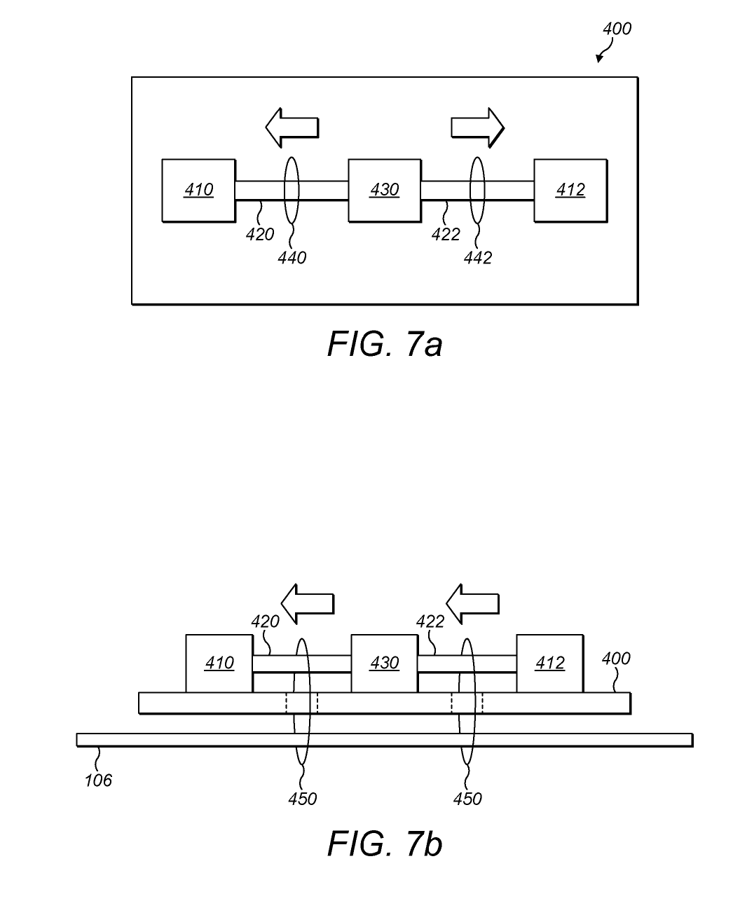

FIGS. 7a and 7b show, respectively, plan and side views of a lance release mechanism according to an embodiment of the present invention;

FIGS. 1a and 1b show scenarios in which an embodiment of the present invention finds use. A tall structure, such as a multi-story dwelling or a residential tower block 1 requires coating periodically with a substance such as an algicide, as explained previously.

In order to apply a coating to the full height and width of each side of the structure 1, a remotely piloted RPAS 100 is used. The RPAS 100 essentially takes the form of an adapted multi-rotor unmanned aerial vehicle (UAV), such as a hexacopter or octocopter. The RPAS 100 must be capable to being controlled remotely and be able to move smoothly and methodically relative to the building 1. A suitable UAV is a DJI S1000 Plus Octocopter, adapted as set out below. Other UAVs may be used, and the skilled person will be familiar with a range of possible vehicles.

The RPAS 100 includes a body portion 104 (see FIG. 2) which includes a propulsion drive, such as an engine or electric motors, and control means, such as a receiver to receive control signals from a remote pilot 200. Connected to the propulsion drive is one or more rotors 102, which provide lift and attitude control. The actual configuration of the propulsion system is set out lower down. FIGS. 1a, 1b and 2 present conceptual representations only of the system and are not intended to show an actual configuration.

The RPAS 100 is remotely piloted by pilot 200 on the ground, using a remote control device 210. The remote control device uses radio frequency signals to control the operation of the RPAS 100. Suitable remote control devices are usually provided with UAVs and may be adapted as required in order to transmit and/or receive further control systems as required in embodiments of the invention.

In order to apply the algicide or other coating to the structure 1, the RPAS 100 is provided with an umbilical hose 120, which is connected in use to a reservoir 140 located adjacent the lower part of the structure, as shown in FIG. 1a. In an alternative embodiment, the reservoir 140 may be located atop the structure 1, and this is shown in FIG. 1b.

The umbilical cord 120 supplies algicide or other coating substance to the RPAS 100, where it is propelled through a lance 106 to be sprayed towards the structure 1 as required.

The lance 106 is configured to produce a dispersed jet 108 of coating substance to be evenly deposited on the surface of the structure 1.

The coating substance is provided from the reservoir and may be pumped on board the RPAS 100 to achieve the desired pressure for acceptable delivery. Alternatively, the coating substance may be delivered under pressure from the reservoir 140.

In FIG. 1b, where the reservoir 140 is located atop the structure 1, the coating substance is pumped under control of the pilot or operator. Alternatively, the coating substance may be gravity fed to the RPAS 100.

The delivery of substance from the lance 106 may be controlled by a second operator 300 who may conveniently be located at a position from where he can gain a good overview of the RPAS's operation. In the example shown in FIG. 1b, the second operator is shown atop the building 1, but he may be on the ground or even atop another building altogether. The second operator (300) operates the pump 140, including turning it on and off and adjusting pressure as required to control delivery of the coating substance through the lance mechanism.

A second operator 300 may not be required in all circumstances, and the pilot 200 may be able to both pilot the RPAS 100 as well as control the coating operation. Whether an operator and a pilot are required will depend on the specific task being undertaken. In some circumstances, the pilot 200 may be assisted by a pilot's assistant and the second operator 300 is designated the spray operator, whose primary task is to operate the spray.

If a pilot's assistant is required, he will be located near to the pilot, for ease of communication. His tasks may include operating a weather station, monitoring visually the vicinity of the operation for any possible risks, monitoring telemetry and visual feedback provided from the RPAS's on-board camera 110. The pilot's assistant may also operate the pump for delivering the spray.

In order to ensure an even distribution of coating substance to the building 1, The RPAS can follow a laser plumb line down/across the building This task may involve the assistance of the pilot's assistant (if present) who can assist the pilot by means of the video signal conveyed by the camera 110. In an embodiment, the laser plumb line is used as a visual aid for the pilot. He will then adjust the position of the RPAS with the remote control (210) to follow this line. The pilot's assistant will also see this line on the First Person View (FPV) monitor and can assist the pilot by instructing him where to move.

In order to ensure that the RPAS is maintained at a consistent distance from the building 1, a position maintenance system is provided which measures the distance from the building 1 and adjusts the position of the RPAS in order to maintain the distance at a desired value or within a desired range. The distance or range may be pre-set or controlled by the pilot/operator.

The control system make use of one or more sensors to measure the distance from the building 1. The sensor(s) may take the form of LIDAR, ultrasonic or any other suitable form of sensor. In a preferred embodiment, a LIDAR sensor is employed. A particularly suitable LIDAR sensor is a Hokuyo UST-20LX.

Typically, the RPAS is intended to operate in the range of 1-5 metres from the wall. It is found that this distance gives optimal performance. The LIDAR sensor used has a range of up to 10 metres and scans the surface of the building 1, with a 270° arc. The Laser beam is rotated 40 times per second and 1080 readings are taken per second. This allows the required degree of accuracy.

The LIDAR sensor is typically only operable in a single plane, which means that any overhangs or irregular features may not be properly dealt with. To accommodate such features, it may be necessary to provide one or more LIDAR sensors oriented in a complementary manner, to provide the required degree of coverage. Alternatively, ultrasonic sensors having a more omni-directional capability and may be used instead or as well.

The RPAS is operable to automatically maintain the desired distance form the building, thereby providing the dual functionality of avoiding collisions and ensuring the correct operating distance.

The RPAS may further be provided with a camera 110, which provides a visual signal, which may be relayed to either or both of the pilot 200 and second operator 300, in order to assist in control of the RPAS 100.

The lance 106 may be provided with a cushioned tip 107 and a detachment mechanism which may be deployed if an imminent collision is detected. The cushioned tip 107 is provided to minimise the risk of the lance 106 damaging a window or other relatively delicate part of the structure. The detachment mechanism may be deployed to jettison the lance 106 if a collision is deemed imminent and may be triggered automatically or manually by a user. The lance may be jettisoned to avoid possible damage to the structure, since the lance would normally be the first part of the RPAS 100 to strike. Furthermore, the RPAS 100 is typically more controllable without the lance, so if an emergency evasive manoeuvre were required, this may be more easy to achieve if the lance 106 is not present.

The detachment mechanism may also jettison the umbilical 120, provided that the RPAS 100 may be controlled wirelessly from the remote control 210.

In one embodiment, the umbilical 120 carries the coating substance and there is no further electrical/data connection carried by or with the umbilical 120. In this case, when the lance 106 is jettisoned, the umbilical, which is connected directly to the lance, falls away too.

In another embodiment, where the umbilical also supplies power and/or data in one or more electrical connections, then the electrical and/or data connection must also be decoupled when the lance is jettisoned. In order to facilitate this, any electrical and/or data connections are made between the umbilical and the main body of the RPAS via a remotely operable coupling, which can be instructed, as part of the lance detachment procedure, to decouple and thereby allow the electrical and/or data connections to fall away with the lance.

The RPAS must remain controllable in such circumstances and the wireless remote control is operable to pilot the RPAS safely. In the event that power is supplied via the umbilical, then a small auxiliary power source, such as a battery, is provided on-board the RPAS with sufficient charge to allow the RPAS to safely reach the ground in the event that external power is disconnected.

The detachment mechanism, shown in plan and side views in FIGS. 7a and 7b, may take the form of a plate 400 attached to the base of the RPAS 100. Preferably, the plate 400 is formed from carbon fibre. The lance is suspended from a lower surface of the plate, and the upper surface houses the detachment mechanism. The detachment mechanism comprises a pair of servos 410, 412. Each servo 410, 412 drives a separate rod 420, 422, each of which has a free end which is housed in a retaining block 430, preferably formed from nylon. Looped around each rod 420, 422 and passing through holes 440 and 442 in the plate is a wire loop 450. The wire loop is thus retained by the rods 420, 422 and is used to hold the lance 106 below the plate, in use.

In the event of an emergency, the servos 410, 412 are operated to retract the rods 420, 422 from the block 430. This action is shown by the oppositely directed arrows, indicating the direction in which each rod will move. This retraction causes the wire loops 450 to be released, falling through the holes 440, 442, thereby allowing the lance to fall under gravity to the ground.

The umbilical hose 120 has its length controlled by the second operator 300 or pilot's assistant, either by him manually feeding in or out a suitable length or remotely by means of a winch-type machine which can feed the hose 120 in and out under his control, or automatically, depending on the altitude of the RPAS 100.

The second operator 300 is responsible for operating the spray lance to issue coating substance as required and as guided by the laser plumb line. He is also responsible for moving the laser plumb line as the RPAS changes position with respect to the building 1. The second operator is also responsible for monitoring the airspace surrounding the building 1 to look out for other aircraft in the vicinity, birds or other possible threats. As mentioned previously, the tasks of the second operator 300 may be performed by the pilot 200, depending on the precise circumstances.

While the RPAS 100 is in operation, the area surrounding the building 1 should be monitored to ensure that passers-by are kept away. A monitored security cordon may be put in place. In cases where a second operator 300 is used, he may be responsible for ensuring the integrity of the cordon.

Placed at the bottom of the building 1, while the RPAS 100 is deployed, is an over-spray collection reservoir 160, which catches any excess coating substance for recycling or responsible disposal. The reservoir may simply take the form of an open container. It may be covered by a grill to prevent debris, such as leaves, from entering it.

The RPAS 100 may be powered by internal means, such as electrical cells. To extend the flight time, power may be relayed to the RPAS via an electrical supply cable coupled to the umbilical hose 120, with a primary power source provided adjacent to the reservoir 140. Furthermore, a data cable may be coupled to the umbilical hose 120. This may be provided with or without the electrical supply cable, and may be used to convey navigational commands to the RPAS and to receive telemetry and other data from the RPAS. The use of such a cable could be advantageous in cases where a radio link may be vulnerable or unsuitable due to the environment or other prevailing conditions. The data cable may be an electrical or an optical cable.

Data signals may be modulated onto the electrical power connections in the manner of known PLC (Power line communication) methods.

When the coating substance is sprayed under pressure form the lance 106, the RPAS may tend to recoil somewhat and move away from the building 1. In order to counter this, the RPAS may be provided with an auxiliary propeller 112 located at the rear of the RPAS (i.e. on the opposite side to the lance) such that as spray is deployed, the auxiliary propeller 112 operates to counteract the force which tends to push the RPAS 100 away from the building. The auxiliary propeller may be arranged to operate automatically as the spray is emitted, so as to tend to maintain the position of the RPAS with respect to the building.

In another embodiment, one or more further auxiliary propellers are provided at other positions on the RPAS. The first auxiliary propeller referred to above is provided to move the RPAS in or out relative to the structure. One or more further auxiliary propellers may be provided to effect side to side movement with respect to a wall of the structure. In this way, the one or more further auxiliary propellers may be used to move the RPAS in a side to side fashion to effect coating of a surface of the structure.

One possible arrangement of the first and further auxiliary propellers is shown in FIG. 5. This shows the RPAS 100. The main propellers 102 are omitted for clarity. The lance 106 is shown for clarity to illustrate the front of the RPAS 100. At the rear of the RPAS is first auxiliary propeller 112. Also shown on left and right sides, respectively are further auxiliary propellers 114 and 116. By use of these left and right auxiliary propellers, the RPAS can be made to track left and right in a controlled manner.

Note that the number of auxiliary propellers can be adjusted as required. For instance, it may not be necessary to provide left and right auxiliary propellers and only one of these may be required. The auxiliary propeller(s) can be provided with a variable pitch rotor. This can allow greater manoeuvrability and particularly may avoid the need to tilt the RPAS to move position.

The various techniques described herein can be combined as needed or operated individually or in any combination, as required,

FIG. 3 shows a plan view of an RPAS according to an embodiment of the invention. Unlike FIG. 2, which shows a conceptual view of an RPAS 100 according to an embodiment, FIG. 3 shows a more typical arrangement of the rotor system 102, which comprises a plurality of individual rotors 102a. Each rotor 102a is individually controllable by the propulsion system to achieve and/or maintain a particular position with respect to the structure 1. The particular position may be thought of as a location defined in terms of x, y and z co-ordinates, and the navigation system, and the position maintenance system are operable to control the position of the RPAS 100.

As an alternative to, or possibly in addition to previous elements for controlling RPAS position, the RPAS position can be controlled by thrust vector control (TVC). This is illustrated in FIG. 4. The TVC system comprises one or more adjustable chutes 250 or flaps 260, positioned to divert the airflow from one or more propellers 102 and so provide an additional motive force, which acts to move the RPAS position. The operation of the TVC system is preferably automated, such that is operates in response to a change in position or attitude of the RPAS, for instance, when a coating substance is ejected from the lance. It could also operate to maintain position in the event of a gust of wind or other disturbance.

The position maintenance system is operable to maintain a specific distance from the structure 1 for two reasons. Firstly, this gives greater control over the delivery of the sprayed coating substance. Secondly, it reduces the chance of a collision with the structure. A human operator would find it difficult to provide the desired degree of control, whereas the automated system provided is able to do this.

FIGS. 6a and 6b show schematics of the position maintenance system according to an embodiment of the invention. It is operable to determine a current position 275 relative to the structure, using LIDAR and/or an ultrasonic sensor and compare this to a set distance 275 to calculate an error signal. The system is further operable to measure a current velocity 280 using either the GPS system of LIDAR or ultrasonic sensors. This is then compared with a desired velocity 285 to produce a so-called push-pull demand 290, which is a control system used to command the propulsion system to control the position of the RPAS. The propulsion system may one or more auxiliary propellers and/or TVC, as set out previously.

Due to the spraying environment in which the RPAS is operating, there is a possibility of sprayed mist from the lance interfering in the position maintenance process. As such, embodiments of the present invention are provided with a mist obviation system to address this problem. The mist obviation system is operable to ensure that the RPAS can be controlled safely and accurately in the presence of mist which might otherwise interfere with the various sensors and render the RPAS difficult to control.

In the presence of mist, the ultrasonic sensors can provide a distance reading, but it is a single reading which is not sufficient to control the RPAS. The LIDAR can provide hundreds of readings, but these will be compromised by the mist.

The raw data readings from the sensors are filtered in a RANSAC filter, which acts to remove outliers and ensure that only valid data points are considered. This increases the confidence in the data, which is then fed into a 3D Kalman filter to estimate distance from the structure, current velocity and acceleration in order to control the propulsion system. Using this system, which uses readings from the LIDAR and the ultrasonic sensor(s), it is possible to determine with a required degree of confidence that the distance reading is correct. When the confidence is sufficiently high, the RPAS automatically approaches the structure and maintains its position. When the confidence reading drops below a threshold, the RPAS automatically backs away from the structure until the confidence rises again and the structure can be safely approached.

FIG. 6b shows more detail of the position maintenance system. In particular, it shows how samples from the LIDAR and ultrasonic detector are processed using the RANSAC filter to remove outliers. This generates a confidence measure which is passed to the control system, along with position and velocity information 270, 280.

The Kalman filter is shown in FIG. 6b and its operation will be known to the skilled person. The following features are specifically mentioned and details are provided for completeness:
Lidar—laser scanner providing 40 Hz swipe data
Ultrasonic—ultrasonic sensor providing 10 Hz data
Push-Pull—current pitch of push-pull propeller
RANSAC wall detection—tries to find the wall through the mist
RANSAC outlier rejection—filters out outliers in ultrasonic sensor data
Position, Velocity—estimated position and velocity passed to the control system
Confidence—module responsible for calculating final confidence from 3× inputs
Kalman filter parameters:
   Q (k)—process uncertainty matrix—describe how much drone is affected by external factors, like wind
   F (k)—process matrix—Newtonian laws of motion
   B (k)—control matrix—describes how pushpull input influences the drone
   u (k)—actual push pull input at time (k)
   R (k)—what is current confidence in position/velocity estimates
   H (k)—measurement matrix—describes what sensor actually measure, in our case both measure position relative to the wall
   z (k)—actual measured distance in at time (k)
Kalman filter state:
   x (k-1)—state in previous time step
   P (k-1)—confidence in previous time step
   predict—prediction step of the Kalman filter—use previous position, velocity, pushpull command to estimate where the drone will be in the next step
   x (k) and P (k)—intermediate state and confidence
   update—update step of Kalman filter—use measurement from lidar/ultrasonic to refine position
   x′ (k) and P′ (k)—current state and confidence

Of course, the RPAS is operating in the vicinity of the coating substance which is sprayed at the structure and so there is a strong probability that it will itself become coated with the substance. The RPAS is made waterproof to a required standard. This involves the use of PU18 hydraulic sealant. All the electronic components are housed in a waterproof enclosure and all connections are provided using waterproof connectors.

In addition to providing a coating to a building, embodiments of the invention may find other uses, such as painting structures, or applying a de-icing composition to an aircraft. The basic system requirements are identical. It is merely the target structure and coating composition/substance which differs. Other scenarios will be apparent to the skilled person and embodiments of the present invention may be deployed after adaptation, if required.

Advantageously, by use of an embodiment of the invention, it is possible to perform spraying and/or coating activities which would not be easily achievable without the use of a large amount of bulky, expensive equipment. Use of an embodiment of the invention also reduces the risk of injury (or worse) to operatives carrying out the operations, since no person is required to operate at high, atop a cherry picker or on a high platform/ladder.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An apparatus for applying a substance to a structure, comprising:
a remotely piloted aircraft system, RPAS;
means for ejecting the substance onto the structure;
means for supplying the substance from a reservoir to the RPAS; and
a position maintenance system arranged to maintain a predetermined distance from the structure.

2. The apparatus as claimed in claim 1 wherein the means for ejecting the substance comprises a lance.

3. The apparatus as claimed in claim 2 wherein the lance comprises a relatively cushioned tip proximal the point of ejection.

4. The apparatus as claimed in claim 2 wherein the lance is releasably coupled to the RPAS, such that the lance may be jettisoned if required.

5. The apparatus as claimed in claim 1 wherein the means for supplying comprises an umbilical cable coupled to a reservoir.

6. The apparatus as claimed in claim 5 further comprising the reservoir, arranged to be sited either at ground level or atop the structure.

7. The apparatus as claimed in claim 5 wherein the umbilical cable is further arranged to provide power to the apparatus from an external power source, and/or data between the apparatus and a ground station.

8. The apparatus as claimed in claim 1 wherein the collision avoidance system comprises one or more sensors selected from: a LIDAR sensor; a camera; an ultrasonic sensor; and GPS.

9. The apparatus as claimed in claim 1 further comprising an auxiliary propeller arranged to counteract a force associated with ejecting the substance and to tend to maintain a position or trajectory of the apparatus.

10. The apparatus as claimed in claim 9 wherein the auxiliary propeller has an axis of rotation substantially orthogonal to an axis of rotation of a propeller of a propulsion system of the RPAS.

11. The apparatus as claimed in claim 9 further comprising at least one further auxiliary propeller arranged to facilitate movement in a different direction to that provided by the first auxiliary propeller.

12. The apparatus as claimed in claim 1 comprising thrust vectoring means operable to alter the position of the apparatus in flight.

13. The apparatus as claimed in claim 1 wherein the position maintenance system comprises a RANSAC filter to filter any outlying data points and a Kalman filter to estimate distance from the structure, current velocity and acceleration in order to control the apparatus.

14. The apparatus as claimed in claim 1 wherein at least a part of the apparatus is provided in a waterproof housing.
